(19) United States
(12) Patent Application Publication
(10) Pub. No.: US 2016/0275011 A1
(43) Pub. Date: Sep. 22, 2016

(54) MICROCOMPUTER WITH BUILT-IN FLASH MEMORY, METHOD FOR WRITING DATA TO BUILT-IN FLASH MEMORY OF MICROCOMPUTER, AND PROGRAM FOR WRITING DATA TO FLASH MEMORY

(71) Applicant: KYOTO SOFTWARE RESEARCH, INC., Kyoto-shi, Kyoto (JP)

(72) Inventor: Yasuyuki TANAKA, Kyoto (JP)

(21) Appl. No.: 14/412,398

(22) PCT Filed: Sep. 25, 2014
(86) PCT No.: PCT/JP2014/075462

§ 371 Date: Dec. 31, 2014

(51) Int. Cl. G06F 12/02; G06F 12/12

(52) U.S. Cl. CPC G06F 12/0246; G06F 12/122; G06F 2212/69; G06F 2212/7201

(57) ABSTRACT

A microcomputer with a built-in flash memory includes two memory blocks that are sequentially updated. Each of the memory blocks includes block management information and a plurality of slots that store data. The block management information includes an update counter that indicates order in which data has been updated. Each of the plurality of slots has updated data and a write complete flag (WCM) indicating that writing of the updated data to the slot has been completed. Data in the plurality of slots is updated in predetermined order. The microcomputer further includes memory block detection means (S14) for detecting the most recently updated memory block based on the update counters of the two memory blocks; and slot detection means (S15 to S17) for detecting the most recent slot in which writing of data has been completed most recently in view of the predetermined order and the write complete flag in the memory block detected by the memory block detection means.

### TECHNICAL FIELD

The present invention relates to microcomputers with a built-in flash memory, methods for writing data to a built-in flash memory of a microcomputer, and programs for writing data to a flash memory. More particularly, the present invention relates to microcomputers with a built-in flash memory, methods for writing data to a built-in flash memory of a microcomputer, and programs for writing data to a flash memory, in which power discontinuity is taken into consideration.

### BACKGROUND ART

A method for managing a memory in the event of abnormal termination due to power discontinuity etc. during updating of data on a nonvolatile memory is proposed regarding a microcomputer with a built-in flash memory which is mounted on an IC card etc. For example, such a method is described in Japanese Unexamined Patent Publication No. 2008-305263 (PTL 1). According to this publication, in a method for managing a memory in a nonvolatile semiconductor device that includes a nonvolatile memory including a plurality of memory cell blocks each having a plurality of addresses, and memory control means for controlling a batch erasure process on a memory cell block by memory cell block basis, a write process on a storage area by storage area basis with a predetermined number of addresses being assigned to each storage area or on a bit by bit basis, and a data update process on a memory cell block by memory cell block basis, the data update process includes a plurality of element processes, each memory cell block includes a data area and a status information storage area that stores status information capable of identifying the element process being in execution, and the status information has such a data configuration that can update the status information storage area with status information of the subsequent element process to be executed by merely executing a overwrite process. Each memory cell block needs to store a logical address in addition to a physical address (Paragraph [0048] of PTL 1).

### CITATION LIST

### Patent Literature

PTL 1: Japanese Unexamined Patent Publication No. 2008-305263

### SUMMARY OF INVENTION

### Technical Problem

In the conventional microcomputers with the built-in flash memory, the data update process for the nonvolatile memory contained in the microcomputer and the process in the event of abnormality such as power discontinuity are performed as described above. Such microcomputers require a bit-by-bit write process, and each memory cell block needs to store a logical address in addition to a physical address.

However, the need to store a physical address and a logical address increases data for managing user data that should be stored. Accordingly, the built-in flash memory of the microcomputer cannot be effectively used, and the processing speed is reduced.

The present invention was developed in order to solve such problems, and it is an object of the present invention to provide a microcomputer with a built-in flash memory, a method for writing data to a built-in flash memory of a microcomputer, and a program for writing data to a flash memory, which allows the flash memory to be effectively used, can save space, eliminate the need to perform an unnecessary data write/read operation to handle power discontinuity etc., and can achieve power saving.

### Solution to Problem

A microcomputer with a built-in flash memory according to the present invention includes two memory blocks that are sequentially updated. Each of the memory blocks includes block management information and a plurality of slots that store data. The block management information includes an update counter that indicates order in which data has been updated. Each of the plurality of slots has updated data and a write complete flag indicating that writing of the updated data to the slot has been completed, and data in the plurality of slots is updated in predetermined order. The microcomputer further includes: memory block detection means for detecting the most recently updated memory block based on the update counters of the two memory blocks; and slot detection means for detecting the most recent slot in which writing of data has been completed most recently in view of the predetermined order and the write complete flag in the memory block detected by the memory block detection means.

Preferably, the memory block is configured to have a predetermined format, the memory block has a format complete flag indicating that the memory block has been configured to have the predetermined format, and the block management information includes the format complete flag.

More preferably, the memory block has an erase complete flag indicating that erasure of the memory block has been completed, and the block management information includes the erase complete flag.

The memory block may have a predetermined size of user data, and the block management information may include the size of the user data.

The block management information may include a bit-inverted counter obtained by bit-inverting the update counter.

Another aspect of the present invention is directed to a method for writing data to a built-in flash memory of a microcomputer including two memory blocks that are sequentially updated. Each of the memory blocks includes block management information and a plurality of slots that store data. The block management information includes an update counter that indicates order in which data has been updated. Each of the plurality of slots has updated data and a write complete flag indicating that writing of the updated data to the slot has been completed. Data in the plurality of slots is updated in predetermined order. The method includes the steps of detecting the most recently updated memory block based on the update counters of the two memory blocks; and detecting the most recent slot in which writing of data has been completed most recently in view of the predetermined order and the write complete flag in the memory block detected in the detection step.

Still another aspect of the present invention is directed to a program for writing data to a built-in flash memory of a microcomputer including two memory blocks that are sequentially updated. Each of the memory blocks includes block management information and a plurality of slots that store data. The block management information includes an update counter that indicates order in which data has been updated. Each of the plurality of slots has updated data and a write complete flag indicating that writing of the updated data to the slot has been completed. Data in the plurality of slots is updated in predetermined order. The program is executed so as to include the steps of; detecting the most recently updated memory block based on the update counters of the two memory blocks; and detecting the most recent slot in which writing of data has been completed most recently in view of the predetermined order and the write complete flag in the memory block detected in the detection step.

According to the present invention, two memory blocks are used, the most recently updated one of the two memory blocks is detected, and the most recent slot in which writing of data has been completed most recently in the detected memory block is detected. Accordingly, which slot has the latest update data can be determined.

### Advantageous Effects of Invention

It is not necessary to perform a bit operation and to store physical and logical addresses as in conventional examples in order to handle power discontinuity.

As a result, a microcomputer with a built-in flash memory, a method for writing data to a built-in flash memory of a microcomputer, and a program for writing data to a flash memory can be provided which allow the flash memory to be effectively used, can save space, eliminate the need to perform an unnecessary data write/read operation to handle power discontinuity etc., and can achieve power saving.

### BRIEF DESCRIPTION OF DRAWINGS

FIG. 1 is a block diagram showing the overall configuration of a microcomputer with a built-in flash memory.

FIG. 2 is a diagram showing two blocks having a predetermined format.

FIGS. 3A and 3B are diagrams showing the configuration of a slot and an example of data that is stored therein.

FIG. 4 is a flowchart illustrating transition between blocks and a process to be performed in the event of power discontinuity.

FIG. 5 is a flowchart illustrating switching between the blocks.

### DESCRIPTION OF EMBODIMENTS

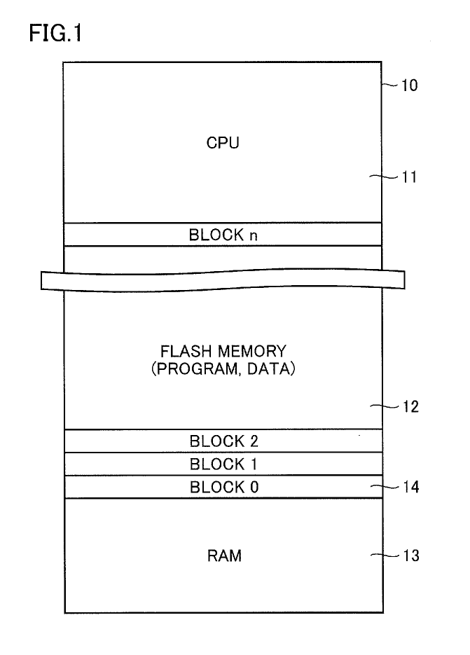

An embodiment of the present invention will be described below with reference to the accompanying drawings. FIG. 1 is a block diagram showing the overall configuration of a microcomputer with a built-in flash memory to which the present invention is applied. Referring to FIG. 1, a microcomputer 10 with a built-in flash memory includes a CPU 11 as a control unit of the microcomputer 10, a flash memory 12 that stores a program for driving the CPU 11 and data, a memory 13 such as a RAM as a work area, and a block area 14 having a plurality of blocks.

The block area 14 includes block 0, block 1, block 2, . . . , and block n.

The flash memory 12 can be used instead of a conventional EEPROM. In this example, the flash memory 12 therefore stores only a single piece of data.

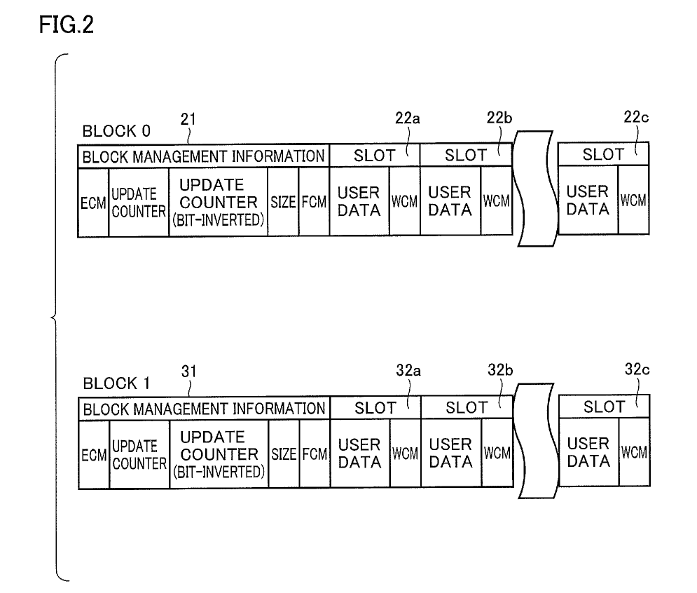

FIG. 2 is a diagram showing a specific configuration of two blocks having a predetermined format and contained in the flash memory 12. In the present embodiment, a process to be performed when the program does not terminate normally such as in the event of power discontinuity is performed by using the two blocks having the predetermined format.

Referring to FIG. 2, the blocks having the predetermined format include block 0 and block 1. Block 0 includes a block management information storage portion 21 and a plurality of slots 22a to 22c.

Block management information includes an erase complete mark (ECM, erase complete flag), an update counter, an update counter (bit-inverted) including inverted information obtained by bit-inverting the update counter, size information of user data, and a format complete mark (FCM, format complete flag).

The ECM contains information (0x5A) indicating that erasure of the block has been completed. The FCM contains information (0xA5) indicating that formatting of the block has been completed. The size information of user data contains the size of user data that is stored in the slots. For example, the size of user data is 16 bytes, 512 bytes, etc.

The update counter contains the order in which data is stored in the slots. An initial value of the update counter is FFFFFFFE (hexadecimal), and the value of the update counter is sequentially reduced to 00000001 (hexadecimal). The update counter (bit-inverted) contains information obtained by bit-inverting the hexadecimal value of the update counter. If the counter information is FFFFFFFE, the update counter (bit-inverted) is 00000001 (hexadecimal). The counter information and the update counter (bit-inverted) are stored in order to determine if the update counter has been correctly written in the event of power discontinuity by using the counter information and the update counter (bit-inverted).

The block management information is written by the following procedure. First, the block is erased. The ECM is written. The update counter and the update counter (bit-inverted) are written. The size information is written. Then, the format complete mark (FCM, format complete flag) is written.

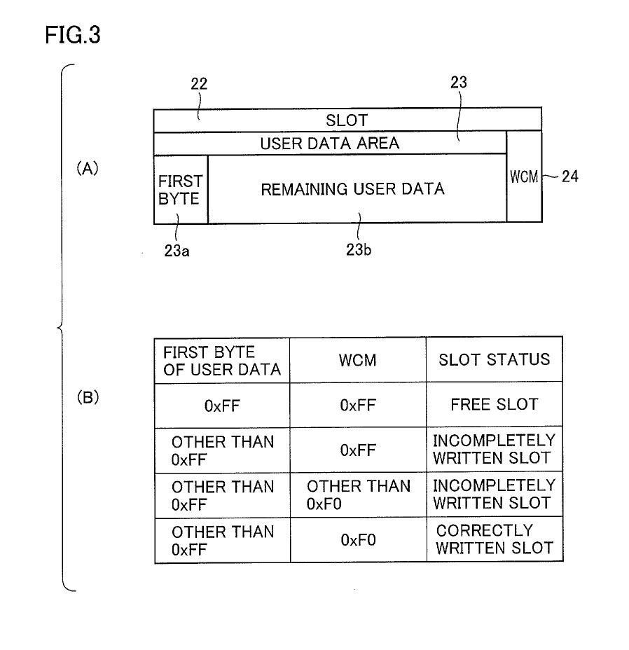

The configuration of the slot and an example of data that is stored therein are shown in FIGS. 3A and 3B. FIG. 3A is a diagram showing the configuration of the slot, and FIG. 3B is a diagram showing data stored at predetermined locations in the slot, and the status of the slot corresponding to the data.

Referring to FIG. 3A, a slot 22 includes a user data area 23 and a WCM recording area 24. When the user writes user data in the user data area 23, the user data is written from the first byte. After the data write operation is completed, a write complete mark (WCM, write complete flag) indicating that the data write operation has been completed is recorded in the WCM recording area 24.

Data is written in order of the ECM, the update counter, the update counter (bit-inverted), the size information, and the FCM. Initial values thereof (when the block has been erased and no data has been written to the block) are padded with 0xFFs.

In a data write operation to the slots, data is first written to the slot 22a of block 0, and then to the slot 22b, . . . , and the slot 22c in this order. If data has been written to all the slots of block 0, namely the status of the block becomes a full block, data is subsequently written to a slot 32a, a slot 32b, . . . , and a slot 32c of block 1 in this order. If data has been written up to the slot 32c, data is subsequently written back to the slot 22a of block 0. This will be repeated thereafter.

Referring to FIG. 3B, the status of the slot can be determined by checking data of the first byte in the user data area 23 and data in the WCM recording area 24. That is, if data of the first byte and data of the WCM are 0xFF and 0xFF, no data has been written in the slot, and therefore the slot is a free slot. If data of the first byte and data of the WCM are either a value other than 0xFF and 0xFF or a value other than 0xFF and a value other than 0xF0, the slot is a slot subjected to power discontinuity etc. during a write operation. If the first byte is not 0xFF and data of the WCM is 0xF0, the slot is a correctly recorded slot.

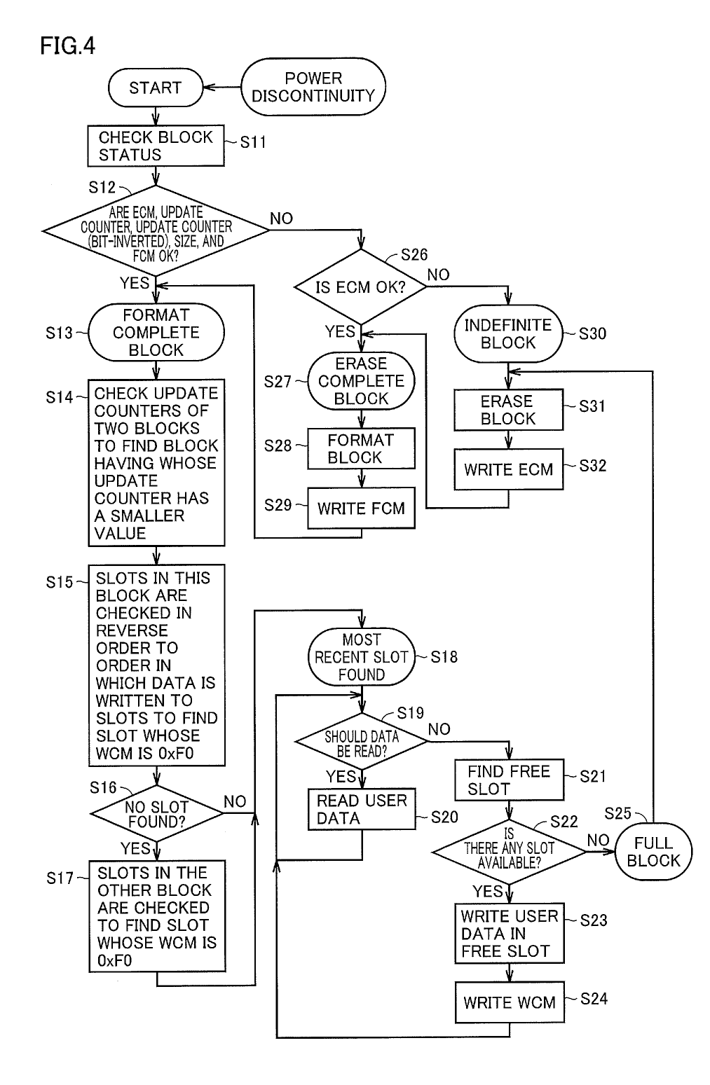

Transition between the blocks and a process to be performed in the event of power discontinuity will be described. FIG. 4 is a flowchart illustrating a process to be performed by the CPU 11 after power discontinuity. Referring to FIG. 4, the status of two blocks is first checked in the event of power discontinuity (step S11, hereinafter the term “step” will be omitted). Whether the ECM, the update counter, the update counter (bit-inverted), the size of user data, and the FCM are ok or not is determined based on the block management information (S12).

If all the values are ok in S12, it is determined that the block is a format complete block (S13). The most recent slot in which the writing of data has been completed most recently is found from the block.

If the values of the block management information are not ok in S12 (erase complete block or indefinite block) (NO in S12), it is determined whether the ECM is ok or not (S26). If the ECM is ok (YES in S26), it is determined that the block is an erase complete block (S27). The block is formatted, and block management information is written to the block (S28). The FCM is written (S29), whereby formatting is completed. The routine then proceeds to S13.

A process to be performed on the format complete block shown in S13 will be described. First, the update counters of the two blocks are checked to find the block whose update counter has a smaller value (S14). The slots in this block are checked in reverse order to the order (predetermined order) in which data is written to the slots to find a slot whose WCM is 0xF0 (S15). If no such slot is found (YES in S16), the slots in the other block are checked to find a slot whose WCM is 0xF0 (S17). This slot is the most recent slot (S18). If such a slot is found in S16 (NO in S16), this slot is the most recent slot (S18).

If the most recent slot is found (S18), it is then determined whether data should be read from this slot or not (S19). If data should be read (YES in S19), the data is read from this slot (S20). Otherwise (NO in S19), the slots are checked to find a free slot (S21). It is determined whether there is any slot available (S22). If there is any slot available (YES in S22), user data is written to the free slot (S23), and the WCM is also written thereto (S24). The routine then returns to S19.

If there is no slot available (NO in S22), the status of the block is a full block (S25). The routine therefore proceeds to S31, where the block is erased (S31). The ECM is written (S32). The block is now an erase complete block, and the routine proceeds to S27. If the ECM is not ok in S26 (NO in S26), the block is an indefinite block (S30), and the routine proceeds to S31.

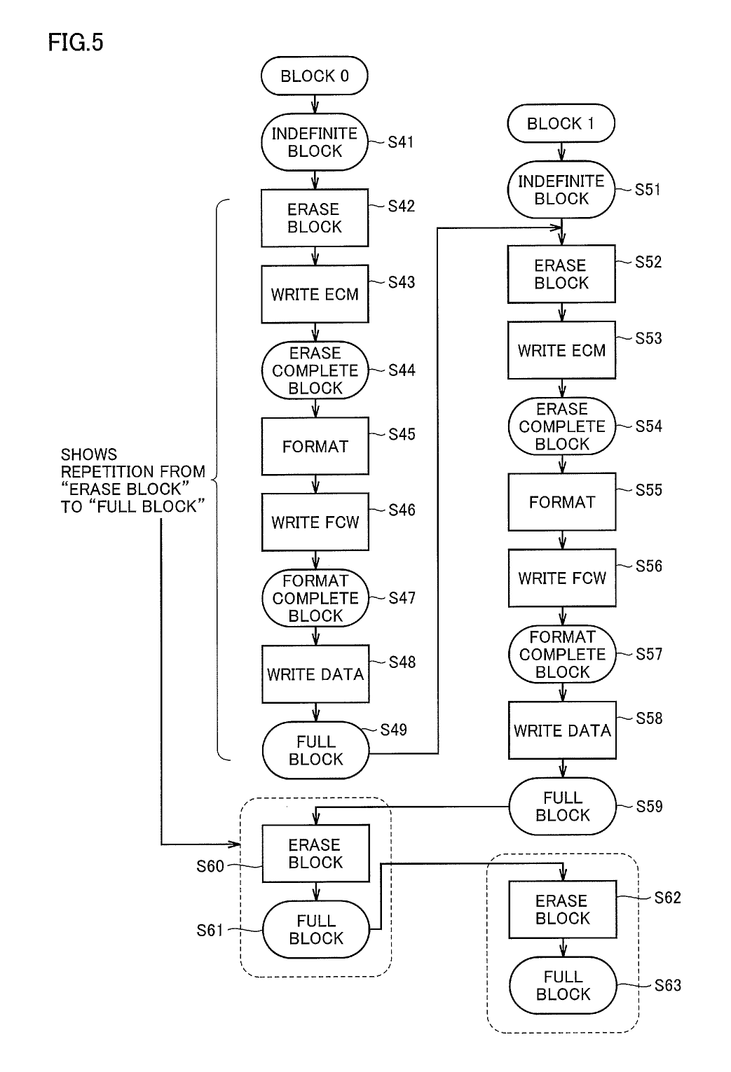

Switching between the blocks will be described below. FIG. 5 is a flowchart illustrating switching between the blocks. Transition between two blocks, namely block 0 and block 1, will be described with reference to FIG. 5.

If block 0 is an indefinite block (S41), the block is erased (S42), and the ECM is written thereto (S43). The block is now an erase complete block (S44). This block is formatted (S45), and the FCW is written thereto (S46). The block is now a format complete block (S47). Data is written to a free slot in the block (S48). If data has been written to every free slot and the status of the block becomes a full block, the routine proceeds to S52, where block 1 is erased.

Block 1 will be described below. Block 1 is processed similarly to block 0. If block 1 is an indefinite block (S51), the block is erased (S52), and the ECM is written thereto (S53). The block is now an erase complete block (S54). This block is formatted (S55), and the FCW is written thereto (S56). The block is now a format complete block (S57). Data is written to a free slot in the block (S58).

If data has been written to every free slot and the status of the block becomes a full block (S59), the above process is performed again on block 0. Namely, the block is erased and formatted, the FCW is written thereto, and user data is written to a free slot until the status of the block becomes a full block (S60, S61). If the status of block 0 becomes a full block, block 1 is processed similarly (S62, S63). This process is repeated thereafter.

As described above, in the present embodiment, the most recently processed block is identified by using two blocks having a predetermined format.

As a result, even if power discontinuity etc. occurs during a process, how much of the process has been completed can be determined, and a new process can be continued from the identified block.

Although the embodiment of the present invention is described above with reference to the drawings, the present invention is not limited to the illustrated embodiment. Various modifications can be made to the illustrated embodiment within a scope that is the same as, or equivalent to, that of the present invention.

### INDUSTRIAL APPLICABILITY

The present invention can provide a microcomputer with a built-in flash memory which eliminates the need to perform an unnecessary data write/read operation to handle power discontinuity etc., which can achieve power saving, and which does not require a bit-by-bit write operation. The present invention can therefore be advantageously used as a microcomputer with a built-in flash memory.

### REFERENCE SIGNS LIST

10 microcomputer with built-in flash memory, 11 CPU, 12 flash memory, 13 RAM, 14 memory block, 20, 31 block management information, 22, 32 slot

1. A microcomputer with a built-in flash memory, comprising:
two memory blocks that are configured to be sequentially updated, wherein
each of said memory blocks includes block management information and a plurality of slots that store data,
said block management information includes an update counter that indicates an order in which data has been updated,
each of said plurality of slots has updated data and a write complete flag for indicating that writing of said updated data to said slot has been completed, and
data in said plurality of slots is updated in a predetermined order, said microcomputer further comprising:
memory block detection means for detecting the most recently updated memory block based on said update counters of said two memory blocks; and
slot detection means for detecting the most recent slot in which writing of data has been completed most recently in view of said predetermined order and said write complete flag in said memory block detected by said memory block detection means.

2. The microcomputer with the built-in flash memory according to claim 1, wherein
said memory block is configured to have a predetermined format,
said memory block has a format complete flag for indicating that said memory block has been configured to have said predetermined format, and
said block management information includes said format complete flag.

3. The microcomputer with the built-in flash memory according to claim 1, wherein
said memory block has an erase complete flag for indicating that erasure of said memory block has been completed, and
said block management information includes said erase complete flag.

4. The microcomputer with the built-in flash memory according to claim 1, wherein
said memory block has a predetermined size of user data, and
said block management information includes said size of said user data.

5. The microcomputer with the built-in flash memory according to claim 1, wherein
said block management information includes a bit-inverted counter obtained by bit-inverting said update counter.

6. A method for writing data to a built-in flash memory of a microcomputer including two memory blocks that are configured to be sequentially updated, wherein
each of said memory blocks includes block management information and a plurality of slots that store data,
said block management information includes an update counter that indicates an order in which data has been updated,
each of said plurality of slots has updated data and a write complete flag for indicating that writing of said updated data to said slot has been completed, and
data in said plurality of slots is updated in a predetermined order, said method comprising the steps of:
detecting the most recently updated memory block based on said update counters of said two memory blocks; and
detecting the most recent slot in which writing of data has been completed most recently in view of said predetermined order and said write complete flag in said memory block detected in said detection step.

7. A program for writing data to a built-in flash memory of a microcomputer including two memory blocks that are configured to be sequentially updated, wherein
each of said memory blocks includes block management information and a plurality of slots that store data,
said block management information includes an update counter that indicates an order in which data has been updated,
each of said plurality of slots has updated data and a write complete flag for indicating that writing of said updated data to said slot has been completed, and
data in said plurality of slots is updated in a predetermined order, said microcomputer is caused to execute said program comprising the steps of:
detecting the most recently updated memory block based on said update counters of said two memory blocks; and
detecting the most recent slot in which writing of data has been completed most recently in view of said predetermined order and said write complete flag in said memory block detected in said detection step.
